(19) United States
(12) Patent Application Publication
(10) Pub. No.: US 2026/0104100 A1
(43) Pub. Date: Apr. 16, 2026

(54) MIXING VALVE FOR THE INDEPENDENT CONTROL OF FLUID PRESSURE AND FLUID TEMPERATURE

(71) Applicant: ABI Interiors Pty Ltd, Carrara (AU)

(72) Inventors: Rhys BEAL, Carrara (AU); Josh KINGON, Carrara (AU)

(21) Appl. No.: 19/349,120

(22) Filed: Oct. 3, 2025

(30) Foreign Application Priority Data
Oct. 3, 2024 (AU) 2024903193

(51) Int. Cl. F16K 11/20

(52) U.S. Cl. CPC F16K 11/202

(57) ABSTRACT

A mixing valve, the mixing valve comprising: a first fluid flow window; a second fluid flow window; a first plate corresponding to the first fluid flow window; and a second plate corresponding to the second fluid flow window; wherein the first plate is at least partially located within a passage defined by and extending through the second plate and wherein the plates are independently moveable; wherein moving the first plate controls a first aspect of the fluid; and wherein moving the second plate controls a second aspect of the fluid.

### TECHNICAL FIELD OF THE INVENTION

The present disclosure is directed to a mixing valve for the independent control of fluid pressure and fluid temperature.

### BACKGROUND OF THE INVENTION

According to existing mixing valves, a fluid control element, such as a mixer handle, connected to mixing valve, is rotated to adjust water flow and water pressure. Rotation of the mixer handle allows control or adjustment of the water pressure, either increasing or decreasing it, and simultaneously allows the adjustment or control of the water temperature.

These existing mixing valves are limited in their functionality in that when the mixing handle is turned to mix hot water with cold water, the valve opens fully and thereby the pressure is at its maximum, without the ability to adjust it. As a result, when the mixing handle is turned to produce a blend of hot and cold water, it is only available at the highest-pressure setting. Existing mixing valves therefore do not allow for adjustment of pressure when using a mix of hot and cold water.

It is generally desirable to overcome or ameliorate one or more of the above mentioned difficulties, or at least provide a useful alternative thereto.

### SUMMARY OF THE INVENTION

One or more embodiments of the present disclosure include a mixing valve, the mixing valve comprising: a first fluid flow window; a second fluid flow window; a first plate corresponding to the first fluid flow window; and a second plate corresponding to the second fluid flow window; wherein the first plate is at least partially located within a passage defined by and extending through the second plate and wherein the plates are independently moveable; wherein moving the first plate controls a first aspect of the fluid; and wherein moving the second plate controls a second aspect of the fluid.

In some embodiments controlling the first aspect of the fluid includes changing a first degree of overlap between the first plate and the first fluid flow window.

In some embodiments controlling the second aspect of the fluid includes changing a second degree of overlap between the second plate and the second fluid flow window.

In some embodiments the mixing valve further includes a fluid flow window plate, the fluid flow window plate defining the first and second fluid flow windows.

In some embodiments the mixing valve further includes a third fluid flow window; wherein the second plate further corresponds to the third fluid flow window; wherein moving the second plate further controls a third aspect of the fluid.

In some embodiments the mixing valve further includes a fluid flow window plate, the fluid flow window plate defining the first, second and third fluid flow windows.

In some embodiments controlling the third aspect of the fluid includes changing a third degree of overlap between the second plate and the third fluid flow window.

In some embodiments when the second plate is moved in a first direction, the second degree of overlap is caused to be increased and the third degree of overlap is caused to be decreased.

In some embodiments when the second plate is rotated in a second direction the second degree of overlap is caused to be increased and the third degree of overlap is caused to be increased.

In some embodiments rotating the second plate in the first direction causes a temperature of a fluid leaving the valve to be increased.

In some embodiments rotating the second plate in the second direction causes a temperature of a fluid leaving the valve to be decreased.

In some embodiments the temperature may be pre-set by rotating the second plate in the first or second direction without any fluid leaving the mixing valve.

In some embodiments, the second plate defines a second flow control opening wherein when the second plate is moved the second degree of overlap is controlled by a second degree of alignment between the second flow control opening and the second fluid flow window.

In some embodiments, the second plate defines a third flow control opening wherein when the second plate is moved the third degree of overlap is controlled by a third degree of alignment between the third flow control opening and the third fluid flow window.

In some embodiments the first aspect of the fluid is a flow rate of the fluid through the mixing valve; the second aspect of the fluid is a volume of comparatively hotter fluid; and the third aspect of the fluid is a volume of comparatively colder fluid.

In some embodiments, rotating the first plate in a first direction increases the rate of flow of the fluid through the valve.

In some embodiments rotating the first plate in a second direction decreases the rate of flow of the fluid through the valve.

In some embodiments the mixing valve further includes a hot fluid inlet and a cold fluid inlet.

In some embodiments the hot fluid inlet and the cold fluid inlet are non-return valves to ensure that the fluid only flows in one predominate direction through the mixing valve.

In some embodiments the non-return valves substantially restrict the fluid from back flowing into one or more supply pipes.

In some embodiments the mixing valve further includes a first rotor configured to engage with the first plate; and a second rotor configured to engage with the second plate.

In some embodiments the mixing valve further includes a first handle configured to engage with the first rotor to enable a user to control the first aspect of the fluid; and a second handle configured to engage with the second rotor to enable a user to control the second aspect of the fluid.

In some embodiments the second handle is further configured to enable a user to control the third aspect of the fluid.

In some embodiments the mixing valve is fluidically connected to a fluid source.

In some embodiments, the second plate includes an inner edge, the inner edge defining the passage extending through the second plate, and wherein the inner edge defines the second fluid flow window.

In some embodiments, the second fluid flow window is a notch.

In some embodiments, the inner edge includes a lip portion configured to overlap with at least the second fluid flow window; and wherein the lip portion includes:
a first end which defines a respective first end of the notch; and
a second end which defines a respective second end of the notch.

In some embodiments, the lip portion extends substantially uniformly around the inner edge of the second plate, from the first end of the lip portion to the second end of the lip portion.

In some embodiments, the valve further includes a third fluid flow window, and wherein:
the second plate is configurable such that the lip portion can completely obstruct either the second fluid flow window, or the third fluid flow window.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Preferred embodiments of the present disclosure are hereafter described, by way of non-limiting example only, with reference to the accompanying drawing in which:

FIG. 1A is an isometric view of a mixing valve;

FIG. 1B is a side on view of the mixing valve of FIG. 1A;

FIG. 1C is a front on view of the mixing valve of FIG. 1A;

FIG. 2A is a semi-exploded view of a mixing valve;

FIG. 2B is another semi-exploded side on view of the mixing valve of FIG. 2A;

FIG. 2C is a sectional view of the mixing valve of FIG. 2A along the line A-A;

FIG. 3A is a sectional view of the mixing valve of FIG. 2A along the line B-B;

FIG. 3B is a sectional view of the mixing valve of FIG. 2A along the line C-C;

FIG. 3C is a sectional view of the mixing valve of FIG. 2A along the line D-D;

FIG. 3D is a sectional view of the mixing valve of FIG. 2A along the line E-E;

FIG. 4 is a schematic diagram that depicts a potential path of the fluid as it enters, travels through and subsequently exits the mixing valve of FIG. 1A;

FIG. 5A is an isometric view of a fixture including a mixing valve of FIG. 1A;

FIG. 5B is an exploded view of the fixture of FIG. 5A;

FIG. 5C is another view of the fixture of FIG. 5A; and

FIG. 5D is another view of the fixture of FIG. 5A.

FIG. 6A is an alternative embodiment of the fixture of FIG. 5A; and

FIG. 6B is another view of the alternative embodiment of the fixture of 6A.

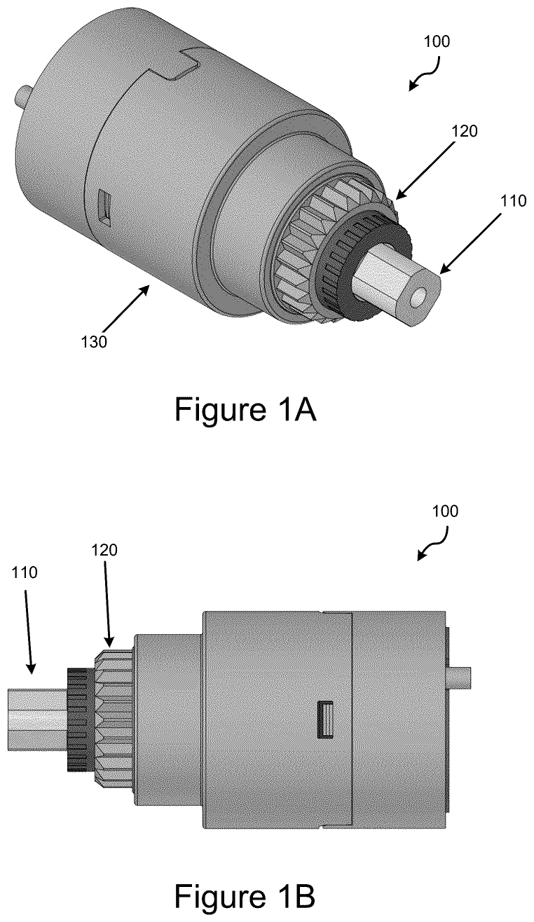

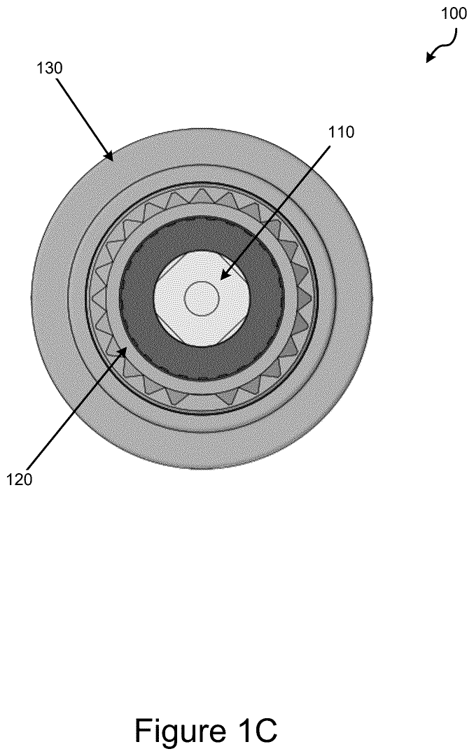

### DETAILED DESCRIPTION OF PREFERRED EMBODIMENTS OF THE INVENTION

The mixing valve 100, according to some embodiments, comprises or defines a first fluid flow window 322; a second fluid flow window 325; a first plate 352 corresponding to the first fluid flow window 322; and a second plate 354 corresponding to the second fluid flow window 325. The first plate 352 is at least partially located within a passage defined by and extending through the second plate 354 and wherein the plates are independently moveable. Moving the first plate 352 controls a first aspect of the fluid; and/or moving the second plate 354 controls a second aspect of the fluid. Wherein the term control includes altering existing aspects of the fluid that is already flowing or may be allowed to flow through the mixing valve 100. Wherein the term control includes setting or pre-setting/pre-selecting aspects of the fluid before or while the fluid is flowing through the mixing valve 100.

The mixing valve 100, is, for example, included in a bathroom or kitchen fixture 500, that allows for independent control of the temperature and the pressure of a fluid, such as water, passing through the mixing valve 100. The mixing valve 100 includes a first fluid control element 110 defining a passage extending along a length of the first fluid control element 110; and a second fluid control element 120 sized to extend through the passage of the first fluid control element 110. When the second fluid control element 120 is inserted through the passage defined by the first fluid control element 110, the first fluid control element 110 and the second fluid control element 120 are independently rotatable about a central axis. Wherein rotation of the first fluid control element 110 moves the first plate 352, thereby controlling a first aspect of a fluid running through the mixing valve 100. Further, wherein rotation of the second fluid control 120 moves the second plate 354 thereby controlling a second aspect of the fluid running through the mixing valve 100. According to some embodiments, the first fluid control element 110 and/or the second fluid control element 120 may be rotors. The rotors may comprise one or more ridges for engaging with a respective handle portion, as discussed in greater detail below.

According to some embodiments, the mixing valve 100 may comprise or include non-return parts 215, configured to ensure that fluid is only permitted to flow into the mixing valve via the inlets 304, 306 and not back-flow out of the inlets 304, 306 into the pipes providing the fluid. The non-return parts 215 may be configured to allow the pre-setting of at least one of the first or second aspects of the fluid without any fluid exiting the mixing valve 100.

The first aspect of the fluid running through the mixing valve 100 is the rate of flow of the fluid running through the mixing valve 100, and wherein moving the first plate 352 in a first direction increases the rate of flow of the fluid through the mixing valve 100, and wherein moving the first plate 352 in a second direction decreases the rate of flow of the fluid through the mixing valve 100. In some embodiments, controlling the volume of water moving through the mixing valve 100 may have the effect of increasing or decreasing the pressure at which the fluid is ejected from an exit conduit, or output fixture, such as a tap faucet or shower head.

The second aspect of the fluid running through the mixing valve 100 is an amount or volume of a comparatively hot fluid passing through the mixing valve 100, and wherein rotating the second plate 354 in a first direction increases the amount of the comparatively hot fluid passing through the mixing valve 100 and rotating the second plate 354 in a second direction decreases the amount of the comparatively hot liquid passing through the mixing valve 100.

The mixing valve may further comprise a third fluid flow window 330 and the second plate 354 may further correspond to the third fluid flow window. According to the embodiment comprising the third fluid flow window 330, when the second plate is moved, a third aspect of the fluid is controlled. According to some embodiments, the third aspect of the fluid is an amount of volume of comparatively cooler fluid. Thus, by moving the second plate, such as by rotating the second fluid control element 120, the overall temperature of the fluid exiting the mixing valve 100 can be controlled.

Put in another way, the mixing valve 100 provides for a user of the mixing valve 100 to pre-set a desired fluid temperature using the second plate 354 and/or second fluid control element 120 and turn on and turn off and adjust the pressure of the fluid coming out of a connected exit conduit using the first plate and/or the first fluid control element 110.

The present mixing valve 100 provides for a reduction in wasted water in comparison to existing systems, by allowing for the preselection of the water temperature, or otherwise the mixing ratio between cold and heated liquid, before “turning on” of the flow of water. In this way, the temperature does not need to be adjusted while the water is flowing. The present mixing valve 100 also allows for mixed liquids to be conveyed out of a conduit (such as a tap or shower head) at different pressures that are not the maximum pressure the system is capable of, thereby reducing the volume of water that must flow through the system for the temperature to be adequate.

The present mixing valve 100 additionally or alternatively provides for a system that is safer than existing mixing valves. The present mixing valve 100 allows for the water temperature to be adjusted prior to any water being allowed to flow out of the system. This may result in a user avoiding scalding water (or fluid of an otherwise dangerous temperature) during the temperature adjustment process.

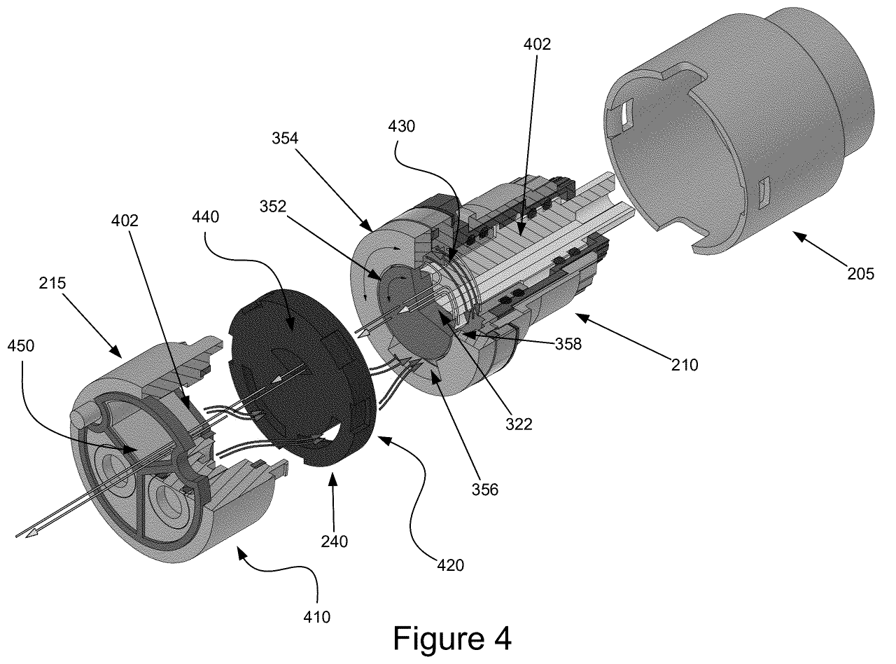

As shown in FIGS. 4A to 4D, the mixing valve 100 may be incorporated or otherwise included in a fixture 200, such as a bathroom sink tap, kitchen sink tap, shower tap, bath tap, outdoor tap, or any other type of fixture that may require mixing of fluids of different properties.

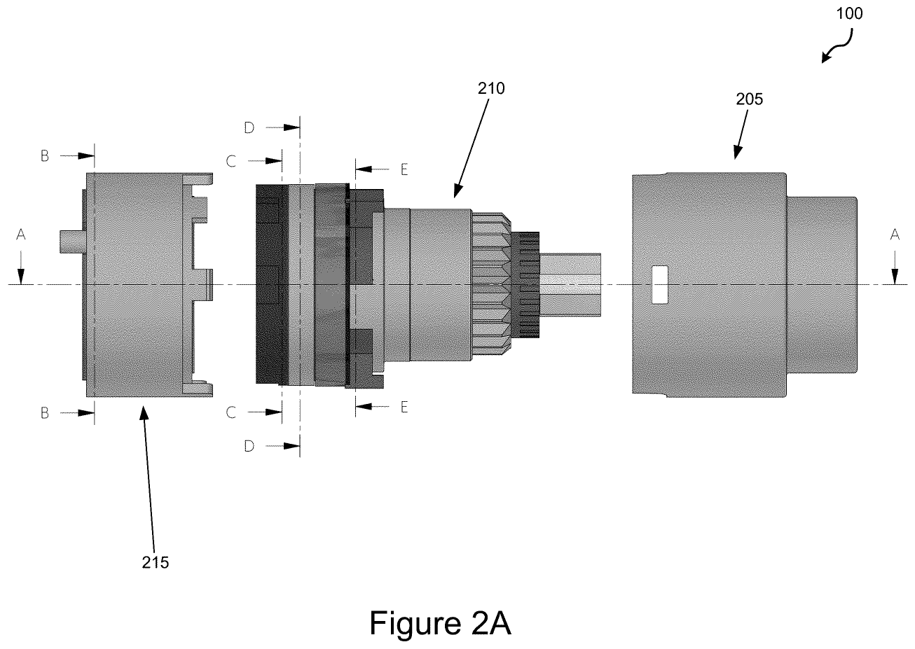

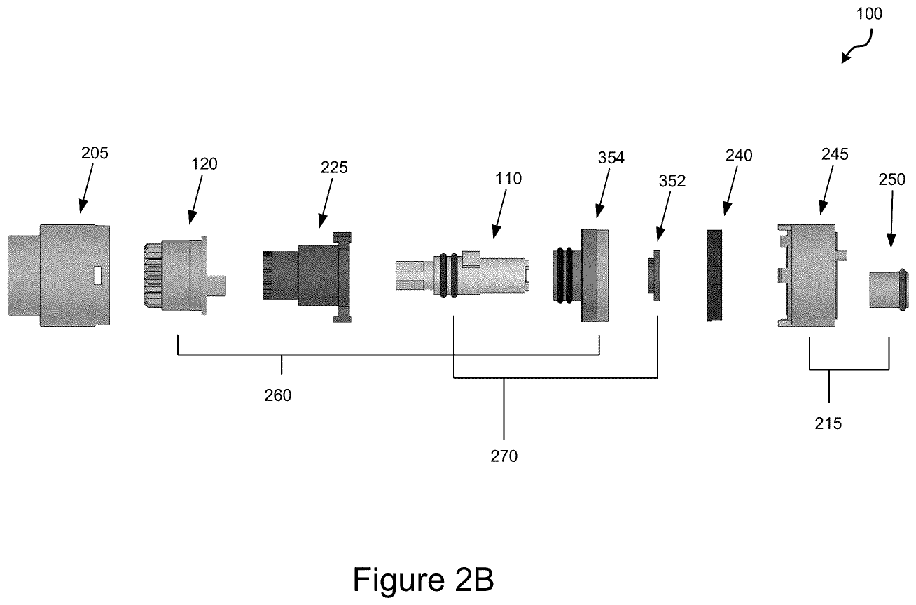

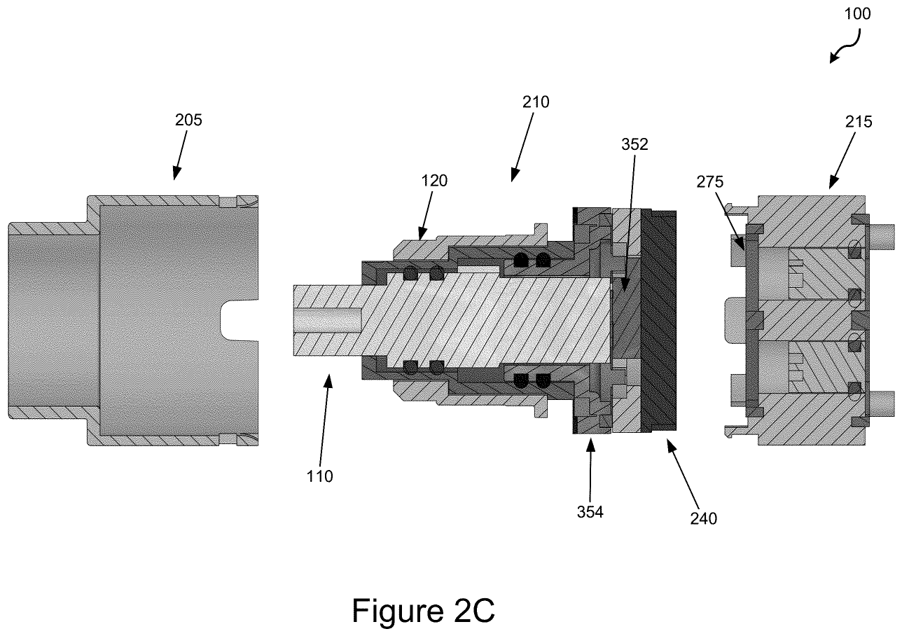

As shown in FIGS. 2A to 2C, the mixing valve 100 includes housing 205, mixing and control parts 210 and non-return parts 215. Housing 205 may be placed over some or all of the mixing and control parts 210 and/or the non-return parts 215 to protect or otherwise cover them.

The mixing and control parts 210 may include fluid mixing parts 260 and/or flow rate mixing parts 270. The fluid mixing parts 260 may include the second fluid control element 120 and the second plate 354. The flow rate mixing parts 270 may include first fluid control element 110 and/or first plate 352. The mixing and control parts 210 may include sleeve 225 configured to at least partially extend between the first fluid control element 110 and the second fluid control element 120, for example for liquid sealing and/or reducing friction between moving parts.

The mixing valve 100 may include the flow window plate 240 that defines the first, second and/or third fluid flow windows 322, 325 and/or 330. The non-return parts 215 may include non-return housing 245 and/or one or more non-return inlet 250. The one or more non-return inlet 250 may be a one-way flow valve configured to enable fluid to enter into the mixing valve 100 but not allow the fluid to back-flow into the fluid pipe that fluid is flowing from. In some embodiments, the non-return inlet 250 comprises a biased portion, biased such that the portion may be configured to move in a first direction when a force is applied to said portion in the first direction, such as fluid pressure, to allow fluid to flow through the non-return inlet 250 into the mixing valve 100. The biased portion may additionally be configured such that when the non-return inlet 250 experiences a force in a second direction, opposing the first direction, the biased portion is not configured to move (or otherwise configured to not move or otherwise resist the flow of the fluid), thereby not allowing fluid to flow in the direction of the second force, for example back into the pipe supplying the fluid.

In some embodiments, the mixing valve 100 may include one or more mesh screens (not shown). In some embodiments, the mesh screen is positioned between the non-return parts and the fluid inlet that supplies the mixing valve 100 with fluid. In some embodiments, the mesh screen may be positioned between the non-return parts 215 and the flow window plate 240.

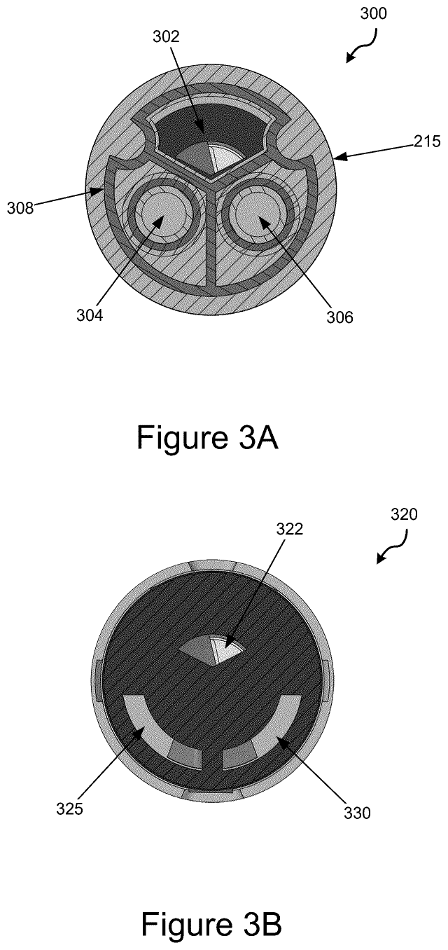

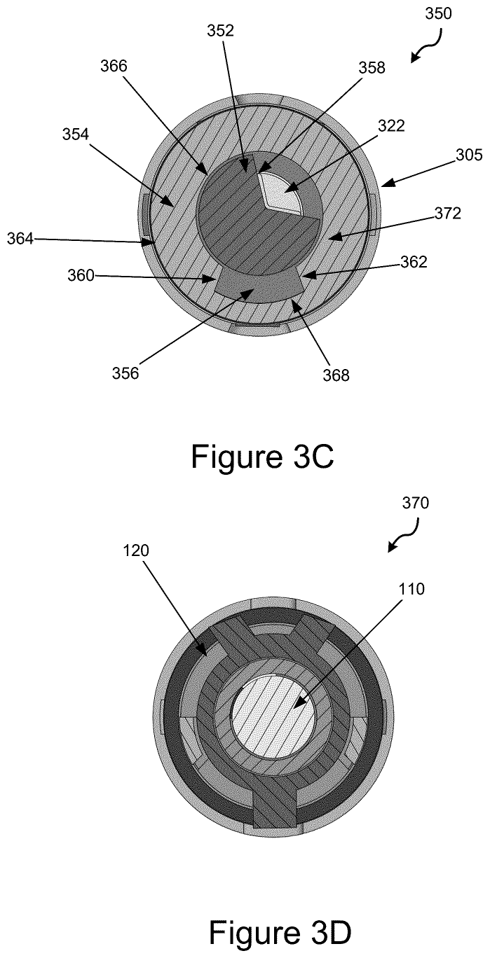

As shown in FIG. 3A depicting the cross-section 300 along line B-B as shown in FIG. 2A, the mixing valve may include first inlet 304 and second inlet 306. In some embodiments, inlets 304, 306 may be hot fluid inlets and/or cold fluid inlets. In some embodiments, inlet 304 is configured to receive hot fluid therethrough. In some embodiments, the inlet 306 may be configured to receive cold fluid therethrough. According to some embodiments, the fluid enters the mixing valve 100 via the one or more inlets 304, 306 and exits the mixing valve 100 via fluid outflow window 302. The mixing valve may comprise seal 308 configured to ensure that the fluid entering the mixing valve 100 does not mix with the fluid exiting the mixing valve 100 and/or the fluid entering via the first inlet 304 does not mix with the fluid entering via the second inlet 306. The inlets 304, 306 may be one way flow inlets such that water that enters the mixing valve is not permitted to exit the mixing valve via the inlets 304, 306. The non-return valve(s) 250 may additionally be configured to restrict the fluid from back-flowing out of the mixing valve 100.

As shown in FIG. 3B depicting the cross-section 320 along line C-C as shown in FIG. 2A, the mixing valve includes the second fluid flow window 325 and/or third fluid flow window 330. As depicted in FIG. 3B, the second and third fluid flow windows 325, 330 may be a curved windows. As depicted in FIG. 3B, the first fluid flow window 322 may be in the shape of a portion of a circle.

In some embodiments, the first fluid flow window 322 has a different shape to the second and third fluid flow windows 325, 330. In some embodiments, the first, second and third fluid flow windows 322, 325, 330 all have the same shape. In some embodiments, the first, second and third fluid flow windows 322, 325, 330 all have different shapes. In some embodiments the second and third fluid flow windows 325, 330 have the same shape. In some embodiments the second and third fluid flow windows 325, 330 have a different shape. However, it will be understood by the person skilled in the art that the windows 322, 325 and 330 could take any suitable shape.

According to the disclosure, the fluid flow windows 322, 325, 330 are positioned or defined by the mixing valve such that the fluid flow through the second and/or third fluid flow windows 325, 330 into the mixing valve 100 is substantially fluidically isolated from the fluid flow moving out of the mixing valve via the first fluid flow window 322. Thereby ensuring that the mixture of the fluids (e.g., hot and cold) can be accurately controlled by the movement (e.g., rotation) of the second plate 354. To facilitate the fluidic isolation of the second and/or third fluid flow windows 325, 330 from the first fluid flow window 322, the mixing valve may comprise one or more seal 275 (FIG. 2C).

As shown in FIG. 3C depicting the cross-section 350 along line D-D as shown in FIG. 2A, the mixing valve 100 comprises the first plate 352 and the second plate 354. The first plate 352 may comprise, define or otherwise include first flow control opening 358. The first flow control opening 358, according to some embodiments, has a shape that corresponds at least partially to the first fluid flow window 322. The second plate 354 may comprise, define or otherwise include second flow control opening 356. The second flow control opening 354 has a shape that at least partially corresponds to at least the second fluid flow window 325. In some embodiments, the second flow control opening 356 has a shape that at least partially corresponds to the shapes of both second fluid flow window 325 and the third fluid flow window 330.

The first and second plates 352, 354, as depicted in FIG. 3C are predominantly circular, or have a predominantly circular shape. According to other embodiments, the first and second plates 352, 354 may have any other shape that is suitable for obstructing and/or aligning (as described herein) with the first or second fluid flow windows 322, 325 respectively. According to some embodiments, the shape of the first and/or second plates 352, 354 may include square, rectangular, ovoid/ovate, rhomboid, triangular, octagonal, pentagonal, hexagonal, heptagonal, and/or nonagonal shape, for example.

As depicted in FIG. 3C, the second plate 354 includes the second fluid flow opening 356. The second fluid flow opening 356 may include an open cut or open notch configuration. The second plate 354 may include outer edge 364 and inner edge 366. The distance of the outer edge 364 from a central point of the second plate 354 (in other words the radius of the circle defined by the outer edge 364), may be larger than the distance of the inner edge 366 from the same central point of the second plate 354 (in other words the radius of the circle defined by the inner edge 366). The inner edge 366 may define an aperture substantially the same size as the radius of the circle defined by the inner edge 366, that extends through the second plate 354. When the second fluid flow opening 356 includes an open notch configuration, the second plate may include first flow opening edge 360, second flow opening edge 362 and/or third flow opening edge 368. The third flow opening edge may comprise a curve that includes approximately the same gradient (or rate of curvature) as the gradient or rate of curvature of the outer edge 364 and/or inner edge 366. Accordingly, the second flow control opening 356 may have a shape or curvature that is substantially identical to the gradient or rate of curvature of the outer edge 364 and/or inner edge 366.

The second plate 354, in some embodiments, includes a lip portion 372. The lip portion may comprise the first flow opening edge 360 and the second flow opening edge 362 and the inner edge 366. Wherein the first flow opening edge 360 and the second flow opening edge 362 define respective ends of the lip portion 372. Wherein the first flow opening edge 360 and the second flow opening edge 362 define where the lip portion ends and the second flow control opening 356 begins. The lip portion 372 may extend around the entire inner edge 366 of the second plate 354. The lip portion may be at least partially defined by the inner edge 366. In some embodiments, the lip portion 372 may include a substantially uniform gradient and/or rate of curvature. The lip portion 372 may be configured and/or sized to overlap so as to completely or substantially completely cover the second fluid flow window 325 and/or the third fluid flow window 330. The lip portion 372 may be configured to overlap with and/or obscure, cover or otherwise block the second fluid flow window 325 and/or the third fluid flow window 330.

The second fluid flow window 356 may be configured or otherwise sized so as to either completely align with the second fluid flow window 325 or the third fluid flow window 330. In other words, the second fluid flow window 356 may be configured or otherwise sized so as to not be able to completely align with both the second fluid flow window 325 or the third fluid flow window 330 at the same time. Correspondingly, the valve 100 may be configured such that the lip portion 372 may only completely obscure one of either the second fluid flow window 325 or the third fluid flow window 330 in any allowable configuration or arrangement of the second plate 354. In some embodiments wherein the lip portion 372 may only completely obscure one of either the second fluid flow window 325 or the third fluid flow window 330 in any allowable configuration or arrangement of the second plate 354, the back flows and/or the first plate 352 (when the first fluid flow window 322 does not overlap with the first fluid control opening 358) restrict fluid from exiting the valve 100 before a user wants it to. This ensures that an attribute of the fluid may be set (e.g., a temperature of the fluid) before the fluid is allowed to exit the valve 100, without having to fully obstruct both the second fluid flow window 325 and the third fluid flow window 330. Thus enabling a simpler design of the second plate 354.

As shown in FIG. 3D depicting the cross-section 370 along line E-E as shown in FIG. 2A, the mixing valve 100 comprises the first fluid control element at least partially extends through, or is at least partially located within the second fluid control element 120.

When in use, fluid (e.g., water) may enter the mixing valve 100 via one or more of the inlets 304, 306. In some embodiments, the fluid entering via one of the inlets (e.g., the first inlet 304) may be comparatively hotter than the fluid entering via the second inlet 306. The fluids that enter via the first and second inlets 304, 306 may be kept fluidically separate by the seal 308.

Subsequent to entering the mixing valve 100, the fluid that entered via the first inlet 304 is caused to flow through the second fluid flow window 325. Additionally, or alternatively subsequent to entering the mixing valve 100, the fluid that entered via the second inlet 306 is caused to flow through the third fluid flow window 330.

The volume of fluid that is enabled to flow through the second fluid flow window 325 can be altered or otherwise controlled by moving the second plate 354. In a possible position, the second fluid flow window 325 may be substantially unobstructed by the second plate 354 thereby allowing the maximum volume of fluid to pass through the second fluid flow window 325. To change the volume of fluid passing through the second fluid flow window 325, the second plate 354 can be moved (e.g., rotated) to partially or fully obstruct or otherwise partially or fully overlap with the second fluid flow window 325. When the plate 354 substantially fully obstructs or aligns with the second fluid flow window 325 the flow of fluid through the second fluid flow window 325 is caused to be substantially stopped.

In some embodiments, to increase or decrease the volume of fluid passing through the second fluid flow window 325 and as depicted in FIGS. 3A-3D, the second flow control opening 356 may be moved (e.g., rotated) to change the degree of alignment or overlap between the second flow control opening 356 and the second fluid flow window 325. In some embodiments, the degree of alignment or overlap includes the proportion of a fluid flow window that is obfuscated or otherwise covered by a corresponding plate.

In one possible position, the second flow control opening 356 may not be aligned or overlap with the second fluid flow window 325, and the second plate 354 is therefore substantially completely or fully obstructing the flow of the fluid through the second fluid flow window 325. As the second plate 354 is moved (e.g., rotated) away from the substantially fully obstructing position, the second flow control opening 356 is caused to progressively align more and more with the second fluid flow window 325 until the second flow control opening 356 completely aligns with the second fluid flow window 325 thereby allowing the maximum volume of fluid to flow through the second fluid flow window 325.

According to some embodiments, the volume of fluid passing through the third fluid flow window 330 may be controlled in a similar way as the volume of fluid flowing through the second fluid flow window 325.

The volume of fluid that is enabled to flow through the third fluid flow window 330 can be altered or otherwise controlled by moving the second plate 354. In a possible position, the third fluid flow window 330 may be substantially unobstructed by the second plate 354 thereby allowing the maximum volume of fluid to pass through the third fluid flow window 330. To change the volume of fluid passing through the third fluid flow window 330, the second plate 354 can be moved (e.g., rotated) to partially or fully obstruct or otherwise partially or fully overlap with the third fluid flow window 330. When the plate 354 substantially fully obstructs or aligns with the third fluid flow window 330 the flow of fluid through the third fluid flow window 330 is caused to be substantially stopped.

In some embodiments, to increase or decrease the volume of fluid passing through the third fluid flow window 330 and as depicted in FIGS. 3A-3D, the second flow control opening 356 may be moved (e.g., rotated) to change the degree of alignment or overlap between the second flow control opening 356 and the third fluid flow window 330.

In one possible position, the second flow control opening 356 may not be aligned or overlap with the third fluid flow window 330, and the second plate 354 is therefore substantially completely or fully obstructing the flow of the fluid through the third fluid flow window 330. As the second plate 354 is moved (e.g., rotated) away from the substantially fully obstructing position, the second flow control opening 356 is caused to progressively align more and more with the third fluid flow window 330 until the second flow control opening 356 completely aligns with the third fluid flow window 330 thereby allowing the maximum volume of fluid to flow through the third fluid flow window 330.

In some embodiments, when the second plate 354 is moved (e.g., rotated) in a first direction, the second plate 354 increases its degree of alignment with the second fluid flow window 325 and correspondingly decreases its degree of alignment with the third fluid flow window 330. Additionally or alternatively, when the second plate 354 is moved (e.g., rotated) in a second direction, the second plate 354 decreases its degree of alignment with the second fluid flow window 325 and correspondingly increases its degree of alignment with the third fluid flow window 330. In this way, as the second plate 354 is moved (e.g., rotated) the ratio of fluid flowing through the mixing valve 100 is controlled. For example, as the degree of alignment or obstruction of a particular fluid flow window increases, the less fluid is enabled to flow through that particular fluid flow window. Conversely as the degree of alignment or obstruction of one particular fluid flow window increases, the degree of alignment or obstruction of the other fluid flow window correspondingly increases. In this way, the ratio of one fluid to another fluid can be changed by moving the second plate 354.

In one configuration, when the second plate 354 is at a first limit of its moveable range (e.g., rotatable range), the second plate 354 substantially fully obstructs the second fluid flow window 325 and does not overlap or align with the third fluid flow window 330. In another configuration, when the second plate 354 is at a second limit of its moveable range (e.g., rotatable range), the second plate 354 substantially fully obstructs the third fluid flow window 330 and does not overlap or align with the second fluid flow window 325. In this way, when the second plate 354 is in the first or second limit of its moveable range (e.g., rotatable range), the fluid passing through the mixing valve 100 is substantially only coming from whichever fluid flow window that is not substantially fully obstructed.

According to some embodiments, the fluid flowing through the second fluid flow window is comparatively hot water, and the fluid flowing through third fluid flow window is comparatively cold water, and by changing the amount of each fluid flowing through the mixing valve 100 the temperate of the fluid leaving the mixing valve 100 can be controlled. In this particular embodiment, the temperature may be controlled independently of the fluid pressure.

According to some embodiments, the mixing valve 100 may comprise a third plate (not shown), wherein the third plate corresponds to the third fluid flow window 330. When the third plate corresponds to the third fluid flow window 330 the second plate 354 may not correspond to the third fluid flow window 330. In other words, when the mixing valve 100 includes the third plate, the second plate 354 may not be configured or shaped to obstruct or align, partially or otherwise, with the third fluid flow window 330.

The third plate may be configured to obstruct, align or otherwise interact with the third fluid flow window 330 in the same or similar way as the second plate 354 obstructs, aligns or otherwise interacts with the second fluid flow window 325 as described above.

In some embodiments, as the second plate 354 is moved (e.g., rotated), the third plate may also be caused to move (e.g., rotate). In some embodiments, both the second plate 354 and the third plate are moveably (e.g., rotatably) connected to the second fluid control element 120, such that when the fluid control element 120 is moved (e.g., rotated), the second plate 354 and the third plate may be caused to move. When the second plate 354 is moved (e.g., rotated), the third plate may be caused to move (e.g., rotate) a similar or substantially similar distance.

According to some embodiments, when the second plate 325 and third plate are moved (e.g., rotated) in a first direction, a degree of overlap or alignment between the second plate 354 and the second fluid flow window 325 may be caused to decrease, and correspondingly, a degree of overlap between the third plate and the third fluid flow window 330 may be caused to increase, thereby increasing the volume of fluid entering the mixing valve 100 through the second fluid flow window 325 and decreasing the volume of fluid entering the mixing valve 100 through the third fluid flow window 330.

Alternatively or additionally, when the second plate 325 and the third plate are moved (e.g., rotated) in a second direction, a degree of overlap or alignment between the second plate 354 and the second fluid flow window 325 may be caused to increase, and correspondingly, a degree of overlap between the third plate and the third fluid flow window 330 may be caused to decrease, thereby decreasing the volume of fluid entering the mixing valve 100 through the second fluid flow window 325 and increasing the volume of fluid entering the mixing valve 100 through the third fluid flow window 330.

The third plate may comprise a third flow control opening (not shown) configured to obstruct, align or otherwise interact with the third fluid flow window 330 in the same or similar way as the second flow control opening 356 obstructs, aligns or otherwise interacts with the second fluid flow window 325 as described above.

Subsequent to the fluids from the second and/or third fluid flow windows 325, 330 mixing in a ratio that is dependent on the position of the second plate 354 and/or third plate, the mixed fluids are then directed through the first fluid flow window 322. The volume of fluid that is permitted to pass through the first fluid flow window 322 is controlled by the positioning of the first plate 352.

The first plate 352 is configured to obstruct, align or otherwise interact with the first fluid flow window 322. When the first plate 352 is moved (e.g., rotated) in a first direction, a degree of overlap between the first plate 352 and the first fluid flow window 322 is caused to be increased, thereby restricting the volume of fluid flowing through the first fluid flow window 322, thereby reducing the pressure of the fluid leaving an exit conduit (e.g., a shower head or tap faucet).

Alternatively or additionally when the first plate 352 is moved (e.g., rotated) in a second direction, a degree of overlap between the first plate 352 and the first fluid flow window 322 is caused to be decreased, thereby allowing a greater volume of fluid to flow through the first fluid flow window 322, thereby increasing the pressure of the fluid leaving an exit conduit (e.g., a shower head or tap faucet). Subsequent to the fluid passing through the first fluid flow window 322, the fluid flows through the fluid outflow window 302 and out of the mixing valve 100.

According to some embodiments, the fluid that flows through the mixing valve 100 may follow a path such as shown in FIG. 4. FIG. 4 includes cross-sectional portions 402, that enable the viewing of internal components and/or structures of the valve 100. It would be understood by the person skilled in the art that in operation the valve 100 would not include cross-sectional portions 402.

At 410, the fluid enters the mixing valve via at least one of inlet 304 and inlet 306. The non-return parts 215 are configured such that the fluid is not permitted to back-flow into the fluid pipe that fluid is flowing from. The non-return parts 215 enable an aspect of the fluid to be changed or altered without the need for fluid to outflow from the mixing valve. For example, the non-return parts 215 may enable a mixing ratio of fluid flowing through the inlet 304 and fluid flowing through the inlet 306 to be altered (e.g., to control the temperature of fluid exiting the mixing valve 100) without the need to allow fluid to exit the mixing valve 100.

In some embodiments, when the first fluid flow window 322 is completely obstructed by the first plate 352 (i.e., when no fluid is permitted to flow through and exit the mixing valve 100), the mixing valve 100 may create a degree of internal pressure, or at least a degree of internal restriction, that when combined with the biasing of the non-return parts 215 substantially prevents fluid from entering the mixing valve 100 via the inlets 304, 306.

In some embodiments, once the fluid has entered the mixing valve 100 at 410, it progresses to at least one of the second fluid flow window 325 and the third fluid flow window 330 at 420. As shown in FIG. 4, the fluid that flows through the inlet 304 flows to the second fluid flow window 325. The fluid that flows through the inlet 306, flows to the third fluid flow window 330. At 420, the position of the second plate (and in some embodiments the third plate), controls the volume of fluid that is permitted to flow through the second and third fluid flow winds 325, 330.

Subsequent to passing through the second and third fluid flow windows 325, 330, the fluid that has flown through each of the respective second and third fluid flow windows 325, 330 is permitted to intermingle or otherwise mix, at 430.

Once the fluid has mixed at 430, the fluid is directed through the first fluid flow window 322 at 440. The position of the first plate 352 will restrict the volume of mixed fluid that is permitted to flow through the first fluid flow window 322.

The mixed fluid, at the pressure as set by the position of the first plate 352, is permitted to exit the mixing valve 100 via the fluid outflow window 302, at 450.

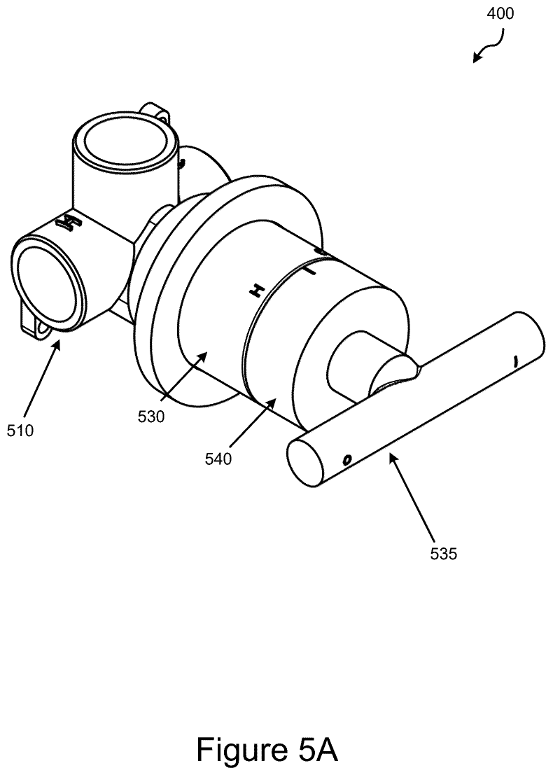

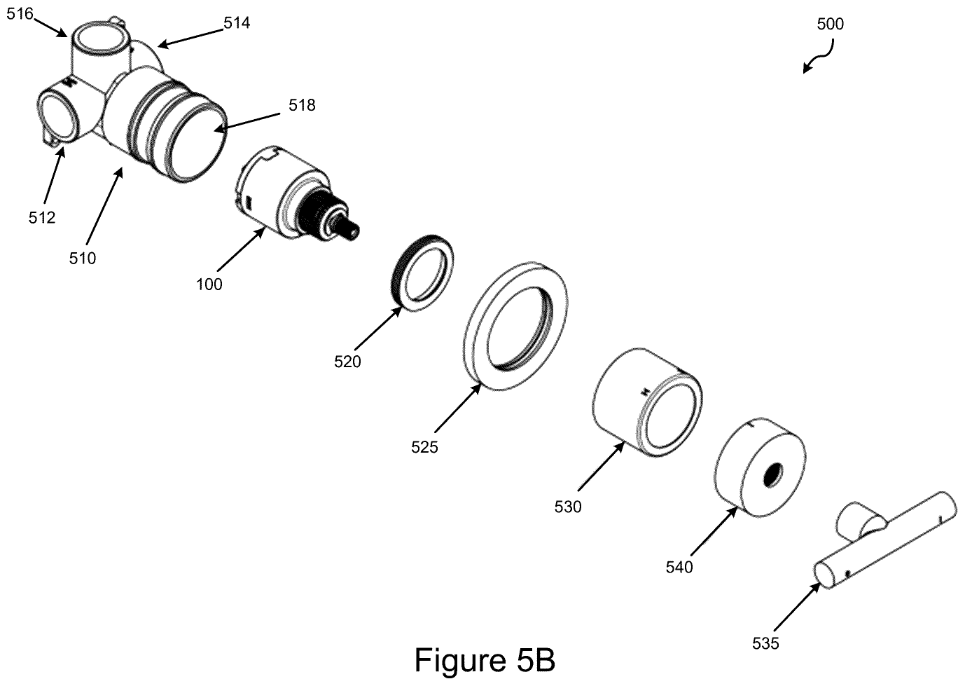

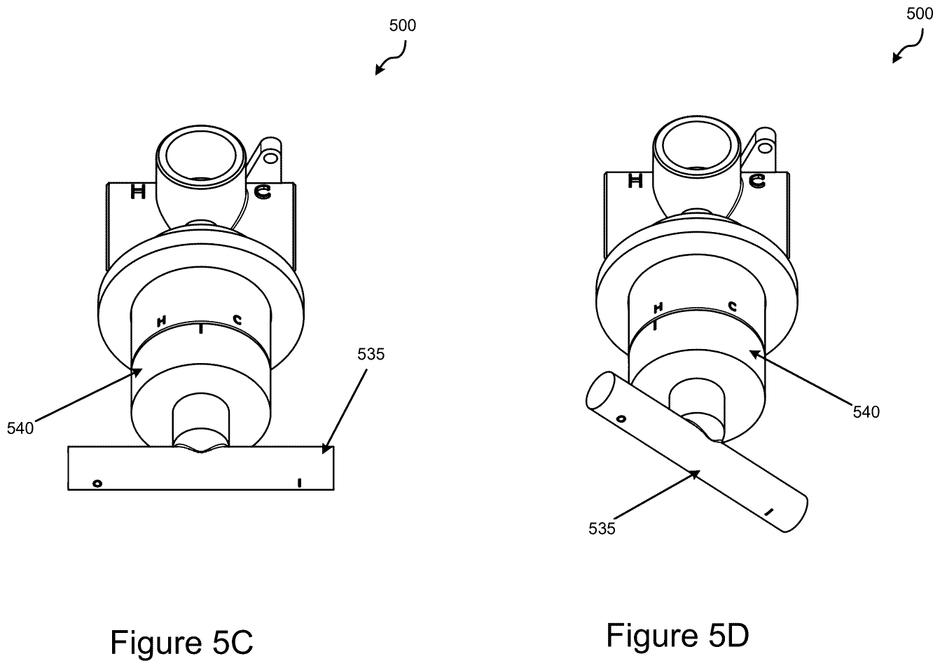

As shown in FIGS. 5A and 5B, the fixture 500 comprises the in-wall body 510. The fixture 500 comprises the mixing valve 100. The fixture 500 comprises the locking nut 520. The fixture comprises the back plate 525. The fixture 500 comprises sleeve 530. The fixture 500 comprises the first handle 535. The fixture 500 comprises second handle 540.

The in-wall body 510 may, in some embodiments, be a water tight housing configured to receive two or more fluids from two or more fluid sources and direct the two or more fluids to the mixing valve 100 for mixing. For example, the in-wall body 510 may define a first inlet 512, a second inlet 514 and a mixer outlet 516. The first inlet 512 may be a hot fluid inlet configured to receive, for example, hot water, heated water or comparatively hot water. The second inlet 514 may be a cold fluid inlet configured to receive, for example, cold water, cooled water, or water that has not been heated, or comparatively cold water. The mixer outlet 516 may be configured to channel the mixed fluids out of the in-wall body 510, for example into a fluid conduit for transporting to a fluid outlet, such as a water pipe (not shown) that is fluidically connected to a shower head (now shown) or tap (not shown). The in-wall body 510 may define mixing valve receiving region 518 configured to receive the mixing valve 100.

The locking nut 520 is configured to engage with the in-wall body 510 to secure the mixing valve 100 within the mixing valve receiving region 518. For example, the locking nut 520 may define a thread configured to engage with a corresponding thread defined by the in-wall body 510 thereby capturing at least a portion of the mixing valve 100, such as valve body 130, within the mixing valve receiving region 518.

In some embodiments, in-wall body 510 is installed within a structure, such as a wall, or a bench, and a hole may be made in the structure for a portion of the mixing valve 100 to protrude through, in this circumstance the back plate 525 may cover the hole formed in the structure.

The sleeve 530 is configured to fit over a portion of the in-wall body 510 to cover and/or hide a portion of the in-wall body 510. For example, a portion of the in-wall body 510, such as the portion of the in-wall body 510 that defines the mixing valve receiving region 518 may be covered by sliding the sleeve 530 over it. In some embodiments, the sleeve 530 may be configured to engage and/or mate with the back plate 525 and/or the in-wall body 510.

The first handle 535 is configured to engage with the first fluid control element 110. In some embodiments, the first fluid control element 110 may define a set of splines configured to engage with corresponding spline receiving regions (not shown) defined by the first handle 535.

The second handle 540 is configured to engage with the second fluid control element 120. In some embodiments, the second fluid control element 120 may define a set of splines configured to engage with corresponding spline receiving regions (not shown) defined by the second handle 540.

As shown in the FIGS. 5A-5D, the second fluid control element 120 may be a cylinder. The second first fluid control element 120 may comprise an outer surface, defining one or more sets of teeth or splines. Additionally, the second fluid control element 120 comprises an inner surface defining a passage that extends at least partially along the length of the second fluid control element 120, and according to some embodiments, entirely along the length of the second fluid control element 120. The splines may be configured to engage with corresponding teeth or splines of the second handle 540, such that when the second handle 540 is rotated the second fluid control element 120 is correspondingly rotated, thereby causing a movement (e.g., rotation) of the second plate 354 and/or the third plate.

The first fluid control element 110 may be a cylinder sized and shaped to fit inside the passage as defined by the second fluid control element 120. In some embodiments, the first fluid control element 110 extends through the passage such that a distal end of the first fluid control element 110 terminates beyond a distal end of the second fluid control element 120.

According to some embodiments, an outer surface of the first fluid control element 110 defines at least one set of teeth or splines configured to engage with the first handle 535. The splines may be configured to engage with corresponding teeth or splines of the first handle 535, such that when the first handle 535 is rotated the first fluid control element 110 is correspondingly rotated, thereby moving the first plate 352.

In some embodiments, when the first fluid control element 110 is inserted through the passage of the second fluid control element 120, the first fluid control element 110 is free to rotate independently from the second fluid control element 120. Similarly, when the first fluid control element 110 is inserted through the passage of the second fluid control element 120, the second fluid control element 120 is free to rotate independently from the first fluid control element 110. In other words, rotation of either the first fluid control element 110 or the second fluid control element 120 will not induce a corresponding rotation of the other fluid control element.

As shown in FIGS. 5C and 5D, the first handle 535 (and therefore the first fluid control element 110 and the first plate 352) is independently rotatable relative to the second handle 540 (and therefore the second fluid control element 120 and the second plate 354 and/or third plate). As shown in FIG. 5C, the first handle 535 is shown in the OFF position, wherein now fluid is permitted or enabled to flow through the mixing valve 100. The second handle 540, as shown in FIG. 5C is in a 50:50 split, wherein the ratio of fluid entering the mixing valve 100 from the second fluid flow window 325 and the third fluid flow window 330 is approximately 50:50.

According to some embodiments, the orientation of the first handle 535 and/or the second handle 540 may be different to that shown in FIGS. 5C and 5D. In some embodiments, the first handle 535 and/or the second handle 540 may be a different shape to those shown in FIGS. 5A to 5D. For example, in some embodiments, handle 540 may be a rounded dial or knob. In some embodiments, the second handle 540 may include one or more protrusions, or may define one or more shapes such as grooves, indentations, knurling or any other suitable shapes or textures.

It would be understood by the person skilled in the art that the position and/or orientation of the first handle 535 and/or the second handle 540 will be dependent on the orientation that the handles are affixed and/or otherwise attached to the fixture 500 and/or the overall shape of the handles 535, 540.

As shown in FIG. 5D, the first handle 535 is rotated in a clockwise direction, which has the effect of moving the first plate 352 such that the degree of overlap between the first plate 352 and the first fluid flow window 322 is comparatively reduced relative to the position as shown in FIG. 5C, thereby increasing the pressure of the fluid exiting the mixing valve 100. As shown in FIG. 5D, the first handle 535 may be in a 50% pressure position. The second handle 540, as shown in FIG. 5D, is rotated in a counter clockwise direction, which has the effect of decreasing the degree of overlap between the second plate 354 and the second fluid flow window 325 and increasing the degree of overlap between the second plate 354 (or third plate) and the third fluid flow window 330, thereby, in this embodiment, increasing the temperature of the fluid leaving the mixing valve 100.

According to some embodiments, the one or more components of the fixture 500 may be removably replaceable. In some embodiments, the sleeve 530 may be removably replaceable. In some embodiments, the first handle 535 may be removably replaceable. In some embodiments, the second handle 540 may be removably replaceable. The removably replaceable components of the fixture may be removed and replaced to change the look or style of the fixture 500. Changing the look or style of the fixture 500 may include changing a material that one or more of the components are made from, such as solid steel, brushed steel, solid brass, brushed brass, solid nickel, brushed nickel, coated steel, coated brass, coated nickel or any other suitable material. Changing the look or style of the fixture 500 may include changing a shape of any one or more of the components. Changing the look or style of the fixture 500 may include changing the size of any one or more of the components. Changing the look or style of the fixture 500 may include changing the finish of any one or more of the components. Changing the look or style of the fixture 500 may include changing the texture of any one or more of the components.

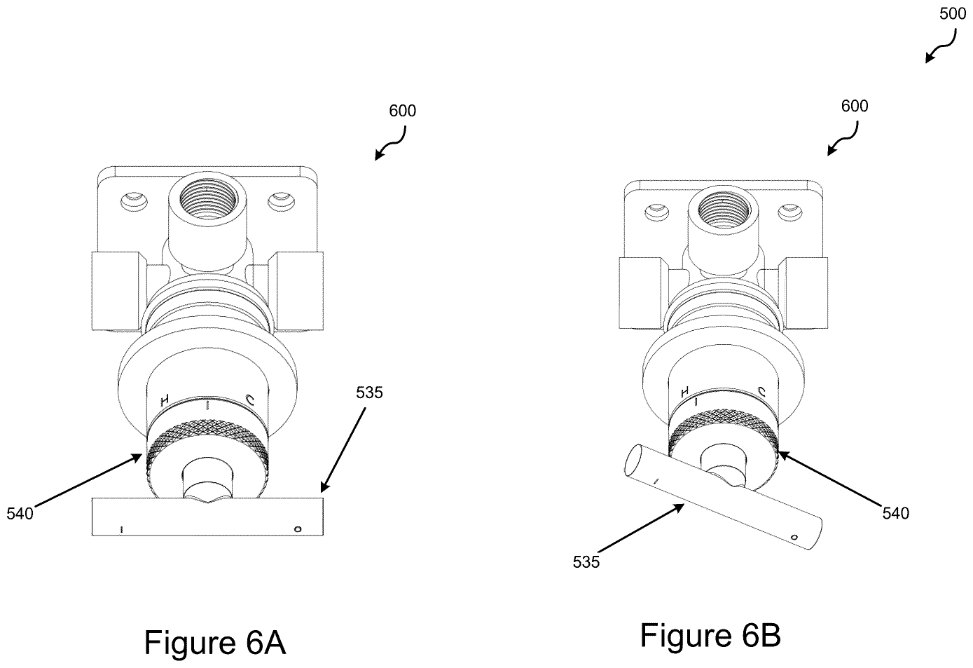

According to some embodiments, and as shown in FIGS. 6A and 6B, the second handle 540 may comprise, define or otherwise include additional features or texture, such as the knolling.

Many modifications will be apparent to those skilled in the art without departing from the scope of the present disclosure.

The reference to any prior art in this specification is not, and should not be taken as, an acknowledgment or any form of suggestion that the prior art forms part of the common general knowledge in Australia In this specification and the claims that follow, unless stated otherwise, the word “comprise” and its variations, such as “comprises” and “comprising,” imply the inclusion of a stated integer, step, or group of integers or steps, but not the exclusion of any other integer or step or group of integers or steps.

References in this specification to any prior publication, information derived from any said prior publication, or any known matter are not and should not be taken as an acknowledgement, admission or suggestion that said prior publication, or any information derived from this prior publication or known matter forms part of the common general knowledge in the field of endeavor to which the specification relates.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheetare incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A mixing valve, the mixing valve comprising:
a first fluid flow window;
a second fluid flow window;
a first plate corresponding to the first fluid flow window; and
a second plate corresponding to the second fluid flow window;
wherein the first plate is at least partially located within a passage defined by and extending through the second plate and wherein the plates are independently moveable;
wherein moving the first plate controls a first aspect of the fluid; and
wherein moving the second plate controls a second aspect of the fluid.

2. The mixing valve of claim 1, wherein controlling the first aspect of the fluid includes changing a first degree of overlap between the first plate and the first fluid flow window.

3. The mixing valve of claim 1, wherein controlling the second aspect of the fluid includes changing a second degree of overlap between the second plate and the second fluid flow window.

4. The mixing valve of claim 1, further including a fluid flow window plate, the fluid flow window plate defining the first and second fluid flow windows.

5. The mixing valve of claim 1, further comprising:
a third fluid flow window;
wherein the second plate further corresponds to the third fluid flow window;
wherein moving the second plate further controls a third aspect of the fluid.

6. The mixing valve of claim 5, further including a fluid flow window plate, the fluid flow window plate defining the first, second and third fluid flow windows.

7. The mixing valve of claim 1, wherein controlling the third aspect of the fluid includes changing a third degree of overlap between the second plate and the third fluid flow window.

8. The mixing valve of claim 6, wherein when the second plate is moved in a first direction, the second degree of overlap is caused to be increased and the third degree of overlap is caused to be decreased.

9. The mixing valve of claim 6, wherein when the second plate is rotated in a second direction the second degree of overlap is caused to be increased and the third degree of overlap is caused to be increased.

10. The mixing valve of claim 8, wherein rotating the second plate in the first direction causes a temperature of a fluid leaving the valve to be increased.

11. The mixing valve of claim 8, wherein rotating the second plate in the second direction causes a temperature of a fluid leaving the valve to be decreased.

12. The mixing valve of claim 11, wherein the temperature may be pre-set by rotating the second plate in the first or second direction without any fluid leaving the mixing valve.

13. The mixing valve of claim 1, wherein the second plate defines a second flow control opening wherein when the second plate is moved the second degree of overlap is controlled by a second degree of alignment between the second flow control opening and the second fluid flow window.

14. The mixing valve of claim 7, wherein the second plate defines a third flow control opening wherein when the second plate is moved the third degree of overlap is controlled by a third degree of alignment between the third flow control opening and the third fluid flow window.

15. The mixing valve of claim 1, wherein:
the first aspect of the fluid is a flow rate of the fluid through the mixing valve;
the second aspect of the fluid is a volume of comparatively hotter fluid; and
the third aspect of the fluid is a volume of comparatively colder fluid.

16. The mixing valve of claim 1, wherein rotating the first plate in a first direction increases the rate of flow of the fluid through the valve.

17. The mixing valve of claim 1, wherein rotating the first plate in a second direction decreases the rate of flow of the fluid through the valve.

18. The mixing valve of claim 1, further comprising a hot fluid inlet and a cold fluid inlet.

19. The mixing valve of claim 18, wherein the hot fluid inlet and the cold fluid inlet include non-return valves to ensure that the fluid only flows in one predominate direction through the mixing valve.

20. The mixing valve of claim 19, wherein the non-return valves substantially restrict the fluid from back flowing into one or more supply pipes.

21. The mixing valve of claim 1, further comprising:
a first rotor configured to engage with the first plate; and
a second rotor configured to engage with the second plate.

22. The mixing valve of claim 21, further comprising:
a first handle configured to engage with the first rotor to enable a user to control the first aspect of the fluid; and
a second handle configured to engage with the second rotor to enable a user to control the second aspect of the fluid.

23. The mixing valve of claim 6, wherein the second handle is further configured to enable a user to control the third aspect of the fluid.

24. The mixing valve of claim 1, wherein the mixing valve is fluidically connected to a fluid source.

25. The mixing valve of claim 1, wherein the second plate includes an inner edge, the inner edge defining the passage extending through the second plate, and wherein the inner edge defines the second fluid flow window.

26. The mixing valve of claim 25, wherein the second fluid flow window is a notch.

27. The mixing valve of claim 26, wherein, the inner edge includes a lip portion configured to overlap with at least the second fluid flow window; and wherein the lip portion includes:
a first end which defines a respective first end of the notch; and
a second end which defines a respective second end of the notch.

28. The mixing valve of 26, wherein the lip portion extends substantially uniformly around the inner edge of the second plate, from the first end of the lip portion to the second end of the lip portion.

29. The mixing valve of 27, further including a third fluid flow window, and wherein:
the second plate is configurable such that the lip portion can completely obstruct either the second fluid flow window, or the third fluid flow window.
